(19) United States
(12) Patent Application Publication
(10) Pub. No.: US 2024/0366050 A1
(43) Pub. Date: Nov. 7, 2024

(54) Flexible Hose, in Particular a Vacuum Cleaner Hose, and Method for Producing Same

(71) Applicant: Truplast Kunststofftechnik GmbH, Langgöns (DE)

(72) Inventors: Ingo Steitz, Staufenberg (DE); Sascha Gärtner, Waldsolm (DE); Marco Holst, Bensheim (DE)

(21) Appl. No.: 18/291,461

(22) PCT Filed: Jul. 29, 2022
(86) PCT No.: PCT/EP2022/071453

§ 371 Date: Jan. 23, 2024

(30) Foreign Application Priority Data
Jul. 29, 2021 (DE) 10 2021 003 907.6

(51) Int. Cl. A47L 9/24; H01R 13/00

(52) U.S. Cl. CPC A47L 9/246; H01R 13/005

(57) ABSTRACT

The invention relates to a flexible hose (10), which has a corrugated-profile inner hose (12) for conveying media along a longitudinal axis (18) and is surrounded, on an outer face (20), by a substantially flat covering (22), and is provided, on at least one of its two ends, with a connection piece. An electrical conductor (30) is situated radially between the inner hose and the covering, which conductor extends from one end to the other end of the inner hose and terminates in the connection piece to provide electrical contact. The electrical conductor is formed by a resilient flat-conductor assembly (32) which extends along the hose in an electrically insulated manner in parallel with the longitudinal axis and is held on the corrugated profile (34) of the inner hose at least by the covering. The invention also relates to a method for producing such a hose on a large scale.

### TECHNICAL FIELD

The present invention relates to a flexible hose according to the preamble portion of claim 1. In particular, the invention relates to a flexible vacuum cleaner hose with one or more electrical conductors, such as is used on a large scale in an industrial environment, in trade and in private households, and to the production thereof.

### BACKGROUND OF THE INVENTION AND PRIOR ART

Vacuum cleaner hoses with integrated electrical conductors also serve the purpose of, for example, electrically connecting vacuum cleaners to motor-driven auxiliary devices for cleaning purposes such as, for example, revolving brushes. In the field of so-called power tools the electrical supply of an electrical tool such as, for example, a hand-held sander can also be realized by way of the suction hose for suction away of dust particles and abrasion particles.

So-called central vacuum cleaners are a further field of use of suction hoses with integrated electrical conductors: In order to be able to conveniently switch on and off central vacuum cleaners located in another room, two electrical conductors are laid in or on and along a hose profile of the suction hose. These conductors are led via a switch arranged in a hand grip of the suction hose. The ends of the two electrical conductors make contact in a connecting member at an end of the suction hose remote from the hand grip with two metallic contact plates which are further connectible with the central vacuum cleaner by way of resilient contact pins seated in a wall connection socket. The contact is closed or opened by actuation of the switch at the hand grip of the suction hose and the central vacuum cleaner switched on and off.

There is no lack of proposals in the prior art as to how electrical conductors can be placed in or on a flexible vacuum cleaner hose. Thus, for example, it is known from documents EP 0 884 019 B1 and DE 298 04 962 U1 to glue to the inner wall of the suction hose an inner hose which forms thereat a protective casing for cable guidance.

However, the glueing-on or glueing-in of the inner hose at the inner wall of the suction hose by, for example, a hot-melt adhesive, works only with relatively short hose lengths. With greater hose lengths the security of the adhesion diminishes, because the hot-melt adhesive during introduction of the inner hose, which is provided with the hot-melt adhesive, into the suction hose cools down too strongly, forms a skin at the surface and no longer fuses with the adhesive partner, i.e. the inner wall of the suction hose.

It is accordingly required for comparatively lengthy vacuum cleaner hoses such as, for example, usually used with central vacuum cleaners to couple individual hose sections of, for example, 2.5 meters length with bushes such as are known from, for example, document EP 1 262 704 B1. However, the complexity connected therewith, including the circumstance that such vacuum cleaner hoses due to the glued-in inner hose are less flexible in one direction than in other directions, is undesirable for many applications.

It was further proposed to run electrical conductors along a flexible vacuum cleaner hose at the outside and, for example, fix them by way of a plurality of clips, loops, straps or tapes seated at intervals on the hose as retainers. Such a suction hose can be inferred from, for example, document DE 10 2013 020 687 A1. A disadvantage of this prior art is to be seen in the fact that the electrical conductor or conductors during bending of the suction hose form loops between the retainers and can disturb the user during work.

As an alternative thereto it is known from document EP 2 614 762 A2 to lay a supply line, particularly a power cable with three individual conductors each with a 2.5 square millimeter line cross-section externally on a suction hose, wherein the supply line and the suction hose are loosely surrounded by an outer hose. Moreover, it is disclosed therein that the supply line in order to achieve a greater variability in length can be wound helically at least once, preferably with three or four windings, around the suction hose. Further, it is proposed in document WO 2019/011591 A1 (FIG. 4) to use a reinforcing body, which is provided in a dust removal hose body of a suction hose for a vacuum cleaner, in the form of a wire helix as an electrically conductive component.

It is also known—see, for example, document DE 91 14 487 U1—to freely lay electrical cables within a suction hose. This construction was primarily proposed for sucking away dust in the case of processing by, for example, abrading. However, the electrical cable forms a flow obstruction and can, particularly in lengthy hoses for central vacuum cleaners, promote blockage in detritus, such as hair or fibers, usual in a household. Such blockages are difficult to eliminate in lengthy hoses.

Moreover, document EP 1 656 873 A2, which forms the preamble portion of claim 1, discloses a vacuum cleaner hose with a plurality of outwardly open grooves, which are of screwthread shape and laterally bounded by ribs and which starting from the groove base open outwardly without narrowing for reception of electrical conductors, and with a braided hose casing covering the grooves and the electrical conductors placed therein.

In this known vacuum cleaner hose the braiding covers the hose casing as seen in a longitudinal section, thus the wave profile formed by the grooves, of an inner hose with the electrical conductors received therein. As a result, the vacuum cleaner hose has a smoothed outer circumferential surface. Improved sliding behavior is thus present by comparison with conventional hoses without a hose casing. In suction operation, during sliding over wall edges, furniture edges, door edges, workpiece edges and bodywork edges there is no snagging of the vacuum cleaner hose with the body edges. As a result, the expenditure of force in vacuuming operation is reduced, there is avoidance of jerky interruptions—caused by snagging—of the movement progress of the user in vacuuming operation, noise development is reduced and, not least, body edges are preserved, thus, in sum, effects which are desirable particularly for hose use with central vacuum cleaners and which in part are also discussed in document WO 2019/011591 A1 with respect to the hose sheathing, which is disclosed therein, of a textile braiding.

However, a disadvantage of this prior art is that compared with the afore-described solutions for laying electrical conductors in or on flexible vacuum cleaner hoses the generic vacuum cleaner hose has as a consequence of its screwthread-shaped line guidance of the electrical conductors a relatively high weight, which is undesirable especially in the case of lengthy vacuum cleaner hoses such as used at, for example, central vacuum cleaners.

In this connection, in the prior art according to document DE 1 218 032 A it is also perceived as disadvantageous with respect to costs, weight and electrical voltage drop to arrange an electrical line in a sinusoidal wave or helically on a resilient hose. Instead, a vacuum cleaner hose is proposed therein in which an electrical stretch cable is secured to a tubular resilient body and in that case extends parallel to a center line of the body, wherein the electrical stretch cable in a stretched state at the tubular body is secured in a tight mutually adjacent sequence so that the electrical stretch cable can compress or stretch between the securing points.

More precisely, the vacuum cleaner hose disclosed in document DE 1 218 032 A comprises a tubular body of a fabric which, for example, is impregnated with rubber. With respect to production and further construction, particularly with regard to “electrical equipping” of this vacuum cleaner hose, the following is in addition stated with reference to FIGS. 1 to 4 of this document: A reinforcing wire helix, for example of steel, is arranged within the tubular body. A cord, for example of jute, is so wound around the tubular body that the windings of the cord lie between the windings of the helix. Before the cord is wound around the tubular body, an electrical stretch cable is placed against the body in such a way that the electrical stretch cable extends in a straight line approximately parallel to the center line of the body. The electrical stretch cable is stretched prior to the cord being wound on. The cord serves for fastening the stretch cable to the tubular body at the places at which the stretch cable is held between the tubular body and a winding of the cord. The tubular body is then provided with a braided casing. The ends of the stretch cable are led out of the casing. A plug can be attached to one end of the cable. The other end of the electrical stretch cable can be connected with a plug socket which is secured to an end of the hose by a clamp.

In distinction from the vacuum cleaner hose disclosed in the generic prior art according to document EP 1 656 873 A2, the vacuum cleaner hose according to document DE 1 218 032 A thus does not have an inner hose which in itself is profiled in wave shape. Rather, the tubular body is here forced between the internally supporting wire helix and the externally constricting cord into a shape which at the same time serves the purpose of fixing the electrical stretch cable to the tubular body at defined mutually spaced points. Such a construction with a multiplicity of components is not only comparatively expensive, also in production, but in addition still has a relative high weight, a degree of “obstruction”—which is undesired for specific cases of use—of the vacuum cleaner hose due to the integrated wire helix, and a poor capability of recycling.

In addition, with respect to the electrical stretch cable of the vacuum cleaner hose according to document DE 1 218 032 A it is to be noted that a two-strand power line, which is thick in relation to the wall thickness of the hose or to the braiding, similar to a loudspeaker cable is illustrated and projects in unsightly manner under the braiding from the rest of the vacuum cleaner hose or leads to an elongate bulge at the hose circumference (cf. FIGS. 3 and 4 of this document). This bulge can impede movements of the hose when, for example, the hose is pulled over an edge or has to roll about its longitudinal axis. According to the description, stretch cables of that kind are stretched by at least 200 percent of the original length. However, technical details with respect to this specially stretchable cable are not described therein.

A further disadvantage of this prior art is to be seen in the fact that the electrical stretch cable has to be significantly stretched, i.e. in the described case of use by at least 33% of the normal length, before it is fastened to the tubular body by the cord so as to be capable not only of lengthening, but also of compressing between the fastening points. This is not only complicated in production, but in addition can have the consequence that the finished vacuum cleaner hose in the unloaded state already has a degree of pre-stretching or pre-curvature, which can be undesirable in, for example, the specific case of use of a central vacuum cleaner. In the case of the previously known embodiment that can certainly be counteracted to a certain extent by a stronger execution of the central reinforcing helix, but this is detrimental to the flexibility of the vacuum cleaner hose.

Finally, a data communications cable and a method of producing such a cable are known from document WO 2020/139199 A1. This data communications cable comprises a set of elongate bodies, which are each formed from a resilient material and have an unstretched free length, and for each of the elongate bodies a set of conductive wires arranged along the elongate body so that each conductive wire is extendable to more than the free length of the elongate body. In that case, at least one conductive wire is configured for communication of data between electronic devices. In addition, the conductive wires are capable of lengthening as a reaction to a lengthening of the lengthwise stretched body, so that the lengthened data communications cable remains usable for data communication between the electronic devices.

In a concrete embodiment of this data communications cable the conductive wires are arranged in sinusoidal, wave or loop shape along the respective elongate body. There is no disclosure in this prior art of any use of such a data communications cable in connection with flexible vacuum cleaner hoses.

### Object

By comparison with the outlined prior art the present invention has the object of designing a flexible hose, particularly a vacuum cleaner hose, with an inner hose, a sheathing and at least one electrical conductor in such a way that the problems discussed above with respect to the prior art are addressed and, in particular, lengthy “electrified” hoses with a comparatively small weight and the afore-mentioned operating characteristics, which are desirable particularly for use at central vacuum cleaners, can be produced economically. The object of the invention also includes indication of a method of producing such a flexible hose provided with at least one electrical conductor, which method enables large-scale production or part making-up, which is as simple, rapid and economic as possible, of the hose with the at least one electrical conductor.

### Illustration of the Invention

These objects are fulfilled by a flexible hose, particularly vacuum cleaner hose, with the features of claim 1 and a method of producing a flexible hose with the method steps of claim 11. Advantageous embodiments of the invention are the subject of the dependent claims.

According to the invention, in a flexible hose, particularly vacuum cleaner hose, which has an inner hose profiled for itself in wave shape—i.e. appropriately pre-shaped—and by an inner side bounds a cavity for the conveying of media along a longitudinal axis of the hose and which is surrounded at an outer side by a substantially smooth sheathing and is provided at at least one of its two ends with a connecting member, wherein an electrical conductor extending from one end to the other end of the inner hose and ending in the connecting member for electrical contact-making is arranged radially between the inner hose and the sheathing, the electrical conductor is formed by a flat conductor arrangement, which is resilient, i.e. in this connection stretchable and compressible against—even if small—restoring forces and which extends along the hose parallel to the longitudinal axis substantially without pre-stress and with electrical insulation and is held at the wave-shaped profiling of the inner hose by the sheathing.

In other words, the electrical conductor—in departure from the generic prior art—is not wound around the inner hose or laid primarily in the circumferential direction of the inner hose. Rather, the electrical conductor extends substantially without pre-stress directly in longitudinal direction of the hose according to the invention and along the hose parallel to the longitudinal axis. The electrical conductor is thereby significantly shorter by comparison with the prior art outlined in the introduction and this is accompanied by an appropriately lower weight and lower costs of the hose.

Through formation of the electrical conductor as a “resilient”—by contrast to (substantially) “rigid”—flat conductor arrangement there is also no necessity for the electrical conductor as seen in longitudinal section of the flexible hose to follow the wave-shaped profiling of the inner hose in the wave course. Rather, the resilient flat conductor arrangement can bridge over the depressions of the wave-shaped profiling at the outer side of the inner hose, whilst it rests on the elevations of the wave-shaped profiling. Nevertheless, the flat conductor arrangement by virtue of its resilient properties is capable of following bendings and/or elongations of the flexible hose without presenting a significant resistance thereto.

In that case, the resilient flat conductor arrangement experiences, for example depending on the bending direction, stretching or compression between the elevations of the wave-shaped profiling of the inner hose. The corresponding applies in the case of compression or tension in the longitudinal direction of the hose. Since the resilient flat conductor arrangement is laid substantially without pre-stress between the inner hose and the sheathing, the hose—due to the resilient flat conductor arrangement—is advantageously free of constraining forces which would impart to the hose a bias or pre-curvature.

Advantageously, apart from the advantages of sheathed hoses already discussed in the introduction the sheathing of the hose according to the invention also serves the purpose as well of holding the resilient flat conductor arrangement on the inner hose, more precisely at the wave-shaped profiling thereof on the outer side of the inner hose. However, depending on the materials used this does not in principle exclude possible additional use of an adhesive or the like between the resilient flat conductor arrangement and the outer side of the inner hose and/or an inner side of the sheathing, which certainly need not noticeably hamper the resilience of the flat conductor arrangement.

In that regard, the electrical conductor as a consequence of its design as a resilient flat conductor arrangement also does not appear excessively “thick”, thus does not lead at the unsheathed hose to a local diameter increase of greater size. The word component “flat” in the expression “flat conductor arrangement” thus in reality speaks to a design of the conductor arrangement in which the length and width dimensions of the conductor arrangement are significantly larger than the thickness dimension thereof. Whereas in that regard the length of the conductor arrangement otherwise results from the desired overall length of the flexible hose, a “significantly larger width dimension by comparison with thickness dimension” in the case of the resilient flat conductor arrangement according to the invention refers to a greater width along the hose circumference with respect to thickness perpendicularly to the longitudinal axis of the hose by at least the factor 10. In a preferred embodiment of the hose according to the invention the ratio of width to thickness of the resilient flat conductor arrangement is approximately in a range between 15 to 1 and 40 to 1, more preferably between 20 to 1 and 30 to 1.

Moreover, since the resilient flat conductor arrangement is mounted on the outer side of the inner hose and not in any way integrated in the inner hose it is advantageously relatively simple to remove the resilient flat conductor arrangement of a hose, which is to be discarded, from the rest of the hose for recycling purposes.

Not least, the construction of the flexible hose according to the invention advantageously allows in the production thereof a (at least) two-stage procedure in which initially the inner hose is produced with its wave-shaped profiling at the outer side before, only in a second step, this “basic hose” is “enhanced” with respect to the desired electrical properties of the hose by mounting and securing of the resilient flat conductor arrangement. As a consequence of this modular construction of the hose, it is thus possible to produce, from one form of module, hoses as desired or required with different resilient flat conductor arrangements, which, for example, can be differentiated by the number of incorporated individual conductors (for example 1, 2, 3 or 4 individual conductors) and/or by the respective effective line cross-section corresponding with the power levels to be transmitted, which ensures a high-degree of flexibility in hose production and also offers cost advantages.

For preference, retention of the resilient flat conductor arrangement at the wave-shaped profiling of the inner hose takes place—in a given case, solely—by the resilient flat conductor arrangement being pressed by the sheathing against elevations of the wave-shaped profile. As seen in radial direction with respect to the longitudinal axis of the hose there is thus a mechanically positive connection, which opposes radial movement of the resilient flat conductor arrangement, for the resilient flat conductor arrangement “sandwiched” or inserted between the inner hose and sheathing.

Conversely, as seen in a direction along the longitudinal axis of the hose or transversely thereto, i.e. in circumferential direction of the hose, there is a friction couple for the resilient flat conductor arrangement, which counteracts longitudinal or transverse displacement of the resilient flat conductor arrangement over the inner hose or under the sheathing. As already mentioned, by virtue of its resiliently deformable construction the flat conductor arrangement can then lengthen or compress, depending on axial deformation and/or bending of the hose, between the individual contact points of the resilient flat conductor arrangement with respect to the inner hose, namely at the elevations thereof, or with respect to the sheathing. For that purpose the resilient flat conductor arrangement in length dimensional direction can have, for example, a resilient stretch capability of between 25% and 75%, for example 50%, in an actual application, depending on the respective case of use.

In order to increase the force or friction couple between the resilient flat conductor arrangement and the inner hose or the sheathing of the hose the resilient flat conductor arrangement or at least a part thereof can additionally be provided with a rubberization or rubber coating, which can be realized with little cost. If, for example, the resilient flat conductor arrangement comprises a knitted fabric or braiding, such (partial) rubberization can be formed, for example, by a rubberized thread being introduced or braided-in.

In principle, it is conceivable for the substantially smooth sheathing of the hose to comprise one or more resilient bands resiliently wound around the inner hose, which is already profiled in wave shape, with the resilient flat conductor arrangement under the band or bands. In addition, the sheathing can be circularly knitted in a circular knitting machine from, for example, textured polyamide threads or the like around the inner hose together with the resilient flat conductor arrangement thereon.

On the other hand, however, a design of the hose is preferred in which the sheathing is formed by a braiding of the inner hose from monofilamentary and/or multifilamentary plastics material threads. Such a braiding advantageously offers firm mechanical retention of the resilient flat conductor arrangement, yet allows a small expansion of the sheathing so as to, for example, be able to engage the ends of the resilient flat conductor arrangement by a tab or the like at the time of final mounting of the hose, so that the resilient flat conductor arrangement for contact-making thereof in the connecting member can be slightly withdrawn from its position between the inner hose and sheathing. If in connection with the present invention there is talk of a sheathing of the inner hose, then primarily hoses braided with round monofilaments, flat monofilaments, plied monofilaments and/or multifilaments are addressed, wherein the monofilamentary of multifilamentary threads of the braiding can optionally even be flocked with short fibers of a thermoplastic plastics material, such as disclosed in document EP 2 363 210 A2.

However, the braiding of the inner hose with monofilamentary and/or multifilamentary plastics material threads does not preferentially serve here as a vehicle for retention of the resilient flat conductor arrangement at the wave-shaped profiling of the inner hose. Due to the supporting effect of the braiding, braided hoses—by comparison with conventional hoses—also have in particular better mechanical properties. Thus, for example, kinking in the case of a braided hose occurs later than in the case of a conventional hose. If the hose is not too tightly braided it is more flexible than a conventional hose, because it can more strongly curve and twist until it kinks. With respect to improved appearance, braided hoses additionally offer the possibility of a more flexible external impression by comparison with conventional hoses.

In order that the bending behavior of the hose is also improved and not worsened by the supporting braiding it is necessary for the braiding to (still) be loosely applied to the hose and not braided as tightly as possible. As a result, the braiding during bending of the hose can compress until the edges of the mutually parallely extending threads abut one another. Only then is a significant counter-force opposing the bending movement built up. If, for example, the braiding is too tightly and narrowly braided, the braided hose no longer has substantially better flexibility compared with the standard hose, but can even have stiffer behavior.

The braiding therefore must not be applied too tightly and narrowly to the hose and/or too strongly compressed on the hose. Depending on whether monofilaments, multiple filaments or both threads in a mixture are braided during the braiding, the properties of the braiding then vary. In the case of a hose loosely braided merely with monofilaments, thus comparatively thick individual fibers, gaps in covering necessarily arise in the braiding. A maximum coverage of the hose circumference of approximately 80% can be achieved here. If a hose braided in that manner is bent then the threads, which slide on one another, of the braiding displace and thus also the coverage gaps, although this braiding is also suitable for retaining the resilient flat conductor arrangement at the wave-shaped profiling of the inner hose.

On the other hand, with a braiding of stretchable and compressible multiple filaments, thus of bundles of fibers, or a hybrid braiding of monofilaments and multifilaments—which is similarly suitable for fixing the resilient flat conductor arrangement on the inner hose—the hose circumference can be braided for complete coverage so that a fabric-like surface arises. Due to the stretchable multiple filaments, braidings of that kind during bending of the hose bear against the outer radius of the bent hose and compress at the inner radius of the bent hose without then forming gaps. However, excessive compression of the braiding on the hose also leads here to hose stiffening or bulging, which may not be desired. This should all be taken into consideration by the person skilled in the art when such person fixes the resilient flat conductor arrangement to the wave-shaped profiling of the inner hose with the assistance of a braiding.

Moreover, in a preferred embodiment of the flexible hose it can be provided that the resilient flat conductor arrangement comprises at least one strand line which as seen in longitudinal direction of the flat conductor arrangement extends in loop-shape or zigzag-shape and is retained in its path by threads which in the manner of a knitted fabric form thread loops, which are looped to form stitches, around the strand line. By virtue of the loop-shaped or zigzag-shaped course of the strand line, which as such has only a low capability of resilient stretching in axial direction, there arises in the resilient flat conductor arrangement a good capability of stretching thereof. In that case, the loop-shaped or zigzag-shaped form of the strand line is stretched or compressed in its wave or triangular course depending on whether the resilient flat conductor arrangement experiences tension or compression in axial direction. Meanwhile, the threads which are looped to form stitches and which extend around the strand line or enclose the strand line as such, ensure the necessary cohesion in the resilient flat conductor arrangement.

If the flexible hose in an electrical “minimal equipping” has merely a resilient flat conductor arrangement with only one strand line, use of the hose is conceivable, for example, in a sphere in which by way of the electrical line of the hose an—optionally additional—earthing of an electrical auxiliary device or power tool with respect to a vacuum cleaner is to take place. However, the flat conductor arrangement will usually have two or more strand lines (for example three or four strand lines) in order, as previously mentioned, to be usable for electrical supply of an auxiliary device or power tool and/or switching functions, in correspondence with the electrical requirements of the respective case of use.

With respect to, in particular, a narrowest possible design of the resilient flat conductor arrangement it is preferred in such a case if the resilient flat conductor arrangement has at least two strand lines which as seen transversely to the flat conductor arrangement extend equally in loop shape or zigzag shape with a mutual axial spacing. The individual strand lines can thus be arranged at a close spacing from one another with mutually “parallel” loop or zigzag shapes without the strand lines during stretching or compression of their respective wave or triangular course mutually contacting or interfering.

In addition, for preference the or each strand line of the resilient flat conductor arrangement can comprise a plurality of metallic individual wires and at least one plastics material thread for tension relief. It is thus possible in simple manner to reinforce the respective strand line or strengthen it against tearing.

In principle, it is possible to insulate the entire resilient flat conductor arrangement so that it extends—electrically insulated—parallel to the longitudinal axis of the hose, for example by foaming the entire arrangement in an electrically insulating, resiliently deformable plastics material foam. On the other hand, however, particularly with respect to low weight and least possible need for installation space it is preferred if the at least one strand line of the resilient flat conductor arrangement is provided with an extruded insulation or insulated by lacquer. A greater degree of stretchability in length of the entire arrangement can thus also be achieved.

Moreover, in a preferred embodiment of the hose the threads of the knitted fabric of the flat conductor arrangement can be resilient at least in part, wherein the threads of the knitted fabric can comprise, for example, a mixture of polyester or polyamide fibers with elastane fibers. These fibers have, with very good availability, a high degree of heat resistance and advantageously have poor flammability. However, in principle, it is also conceivable to achieve cohesion of the individual components in the resilient flat conductor arrangement by a knitted fabric of comparatively rigid threads which, for that purpose, are looped somewhat more loosely or slackly to form stitches so that the necessary deformability can be performed by the individual thread loops of the knitted fabric.

It is, in addition, preferred if the connecting member has a contact region with which the resilient flat conductor arrangement is electrically connected, wherein the contact region can comprise, in particular, at least one slip ring. Thus, for example, in the case of a central vacuum cleaner the rotatability of the hose with respect to a stationary electrical connecting socket can be guaranteed in simple manner by spring-biased contact pins, which are associated with the slip ring or rings, or a connector of such a hose without orientation of the connecting member in rotational angle with respect to the connecting socket. It will be apparent to the person skilled in the art that a mobile vacuum cleaner and/or a terminal appliance can also be provided with such a connecting socket. However, the resilient flat conductor arrangement can obviously also terminate at an end of the hose in a grip or the like with a switch by way of which the electrical conductor is short-circuited, depending on the respective purpose of use of the “electrified” flexible hose suitable therefor.

In terms of method, the present invention provides a method of producing a flexible hose, which comprises at least the following three method steps a) to c): a) forming an inner hose which by an inner side bounds a cavity about a longitudinal axis and has at least at an outer side a profiling which as seen in section has a wave shape with elevations and depressions; b) substantially bias-free mounting of a resilient flat conductor arrangement on the outer side of the inner hose so that the resilient flat conductor arrangement extends along the longitudinal axis and transversely to the elevations and depressions of the profiling; and c) securing the resilient flat conductor arrangement to the outer side of the inner hose by mounting of a sheathing on the wave-shaped profiling.

An important aspect here is the separation of the method steps a) of forming the inner hose on the one hand and b) mounting and c) securing the resilient flat conductor arrangement on and to the outer side of the inner hose on the other hand. This separation of the method steps offers at the outset the advantage that in the manner of a modular system an inner hose of the same basic type can be further enhanced in correspondence with the respective electrical conduction requirements by mounting/securing the resilient flat conductor arrangement or even not at all if this is not necessary or desired.

In addition it is thus possible to selectively further electrically equip an inner hose of the same basic type in correspondence with the respective requirements or wishes by mounting/securing different resilient flat conductor arrangements which differ, for example, in the number and/or line cross-section of the individual conductors, the dimensions thereof and/or the resilience thereof.

This separation of the method steps a) on the one hand and b) or c) on the other hand, however, also leads to advantages in recycling, because the resilient flat conductor arrangement subsequently mounted/secured on and to the outer side of the inner hose can in the case of disposal of the hose fundamentally be more easily removed again than a conductor which is an integral component of the inner hose or received in the inner hose.

Further, due to the fact that in accordance with method step b) the resilient flat conductor arrangement is mounted along the longitudinal axis and transversely to the elevations and depressions of the wave-shaped profiling substantially free of pre-stress on the outer side of the inner hose—in that respect thus exactly the converse in relation to the procedure in the generic prior art, where placement of the conductor takes place transversely to the longitudinal axis and along the profile depressions—merely a simple axial relative movement between the inner hose and resilient flat conductor arrangement is needed during mounting of the resilient flat conductor arrangement. The mounting of the resilient flat conductor arrangement can thus be carried out at maximum speed for a given hose length with minimal use of conductor material. Laborious winding of lengthy and accordingly heavy conductors about the longitudinal axis of the inner hose is eliminated.

In addition, the method step c) is conducive to rapid and cost-efficient production of a flexible (electric) hose in mass production. This is because the fixing of the resilient flat conductor arrangement on/to the wave-shaped profiling of the inner hose and also provision of the flexible hose with a sheathing at the outer side of the inner hose take place at the same time in a common method step.

In principle, the inner hose can be formed, for example, by blow-molding of a suitable plastics material, wherein the wave-shaped profiling can be created on the outer side of the inner hose by appropriately fluted or grooved formation of the mold parts or mold halves of the blow-molding mold. However, on the other hand it is preferred if in step a) of formation of the inner hose initially a profile is extruded from a plastics material, whereupon the profile for formation of the inner hose is helically wound—in a single start or multiple start, corresponding with the respective specifications—wherein adjacent windings of the profile are media-tightly connected together. Advantages of such a wound inner hose by comparison with a blow-molded inner hose are, in particular, that the inner hose can be formed with a substantially smooth inner surface and accordingly low flow losses as well as only low output of noise in operation and in addition higher levels of suction performance can be realized as a consequence of good shape stability and restoration capability.

In that regard, the adjacent windings of the profile are preferably media-tightly connected together by a hot-melt adhesive. This ensures production of the inner hose in a manner which is reliable in terms of process, rapid and economic. However, other connection possibilities, optionally with use of different adhesives, or, for example, creation of a material couple between the individual profile windings by laser welding or the like, are also conceivable.

In addition, the steps b) of mounting and c) of (final) securing of the resilient flat conductor arrangement on and to the outer side of the inner hose by mounting of the sheathing on the wave-shaped profiling of the inner hose can in principle be carried out in succession, in particular when in the case of mounting the resilient flat conductor arrangement a (pre-) fixing to the elevations of the profiling with the assistance of an adhesive agent (for example adhesive or adhesive strip) is carried out. However, on the other hand and particularly with respect to production as rapidly and efficiently as possible it is preferred if the steps b) of mounting and c) of securing of the resilient flat conductor arrangement on and to the outer side of the inner hose are performed at the same time.

Finally, in a concrete embodiment, which is preferred with respect to the above-described actual design of the flexible hose, of the method for producing this flexible hose the wave-shaped profiling of the inner hose can, for formation of the sheathing, be braided with monofilamentary and/or multifilamentary plastics material threads, wherein the resilient flat conductor arrangement is placed substantially without pre-stress at the braiding point on the outer side of the inner hose so that after the braiding point the braided plastics material threads press the resilient flat conductor arrangement against the elevations of the wave-shaped profiling of the inner hose. The feed of the resilient flat conductor arrangement can in that regard be carried out, for example, in simple manner from a spool or roll having a core onto which the resilient flat conductor arrangement is wound.

Further features, characteristics and advantages of the flexible hose according to the invention and the method for production thereof will be evident to the person skilled in the art from the following description of a preferred embodiment.

### BRIEF DESCRIPTION OF THE DRAWINGS

The invention is explained in more detail in the following on the basis of a preferred embodiment with reference to the accompanying partly schematic drawings, in which the same or corresponding parts or sections are provided with the same reference numerals and in which:

FIG. 1 shows a plan view, which is interrupted once, of a flexible hose according to the invention, in particular a vacuum cleaner hose, which is provided on both sides with a connecting member and has therebetween a sheathing—illustrated in FIG. 1 in a detail—in the form of a braiding of an inner hose;

FIG. 2 shows a longitudinal section view, which is interrupted once, of the flexible hose according to FIG. 1;

FIG. 3 shows an illustration, which is to enlarged scale, of the detail III in FIG. 2 in a middle region of the flexible hose according to FIG. 1, showing a resilient flat conductor arrangement inserted between the inner hose profiled in wave shape and the sheathing of the flexible hose;

FIG. 4 shows a sectional view of the flexible hose according to FIG. 1 in correspondence with the section line IV-IV in FIG. 1;

FIG. 5 shows a side view, which is broken away four times, of the flexible hose according to FIG. 1 in a state of being bent into S-shape, wherein the sheathing is shown broken open so as to illustrate how the resilient flat conductor arrangement is capable of following a resilient deformation of the inner hose;

FIG. 6 shows a plan view, which is broken away upwardly and downwardly, of the flexible hose according to FIG. 1 with a viewing direction along the arrow VI in FIG. 5, wherein the sheathing is shown broken open so as to illustrate how the resilient flat conductor arrangement is stretched along an outer curvature of the inner hose;

FIG. 7 shows a plan view, which is broken away upwardly and downwardly, of the flexible hose according to FIG. 1 with a viewing direction along the arrow VII in FIG. 5, wherein the sheathing has been omitted so as to illustrate how the resilient flat conductor arrangement is compressed along an inner curvature of the inner hose;

FIG. 8 shows a plan view, which is broken away on both sides, of the flexible hose according to FIG. 1, wherein the sheathing is shown broken open so as to illustrate how the resilient flat conductor arrangement extends, without deformation, along the hose axis on the inner hose when the hose is not bent;

FIG. 9 shows a perspective view, which is broken away on the left, of the flexible hose according to FIG. 1 obliquely from above and laterally on the left, with a view of the connecting member of the hose at the end thereof on the right in FIG. 9; and

FIG. 10 shows a perspective exploded illustration, which is broken away on the left, of the flexible hose according to FIG. 1 obliquely from above and laterally on the left, particularly for illustration of how the resilient flat conductor arrangement is electrically connected with contact regions in the connecting member.

### DETAILED DESCRIPTION OF THE EMBODIMENT

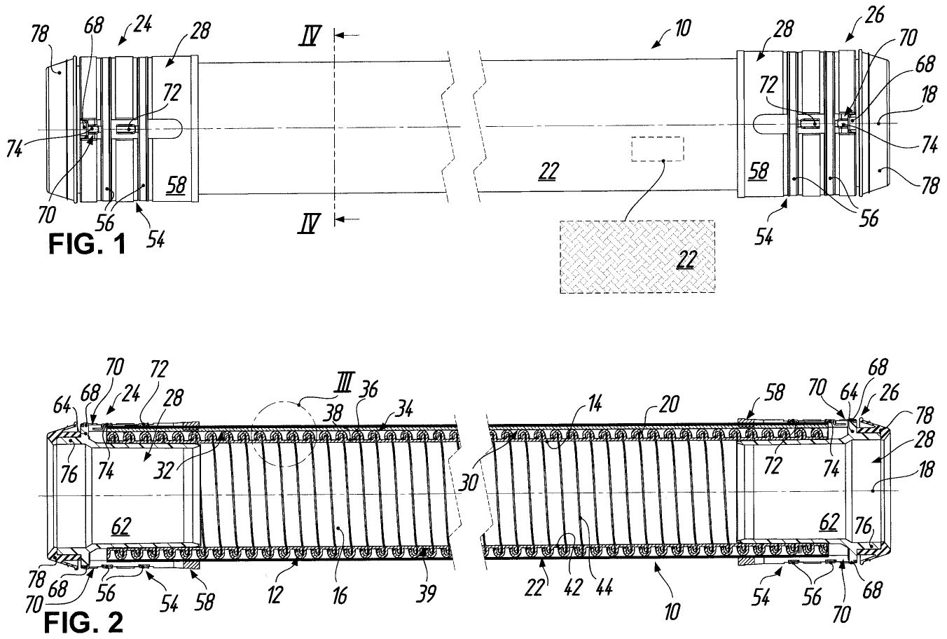

A vacuum cleaner hose as an example for a flexible hose is numbered generally by the reference numeral 10 in the figures. The hose 10 comprises an inner hose 12, which in its itself is profiled in wave shape, i.e. appropriately pre-profiled, and which by an inner side 14 bounds a cavity 16 for the conveying of media along a longitudinal axis 18 of the hose 10. The hose 10 is surrounded at an outer side 20 by a substantially smooth sheathing 22 which in the illustrated embodiment is a braiding of monofilamentary and multifilamentary plastics material threads. According to FIGS. 1 and 2, the hose 10 is additionally provided at at least one of its two ends 24, 26—here at both ends 24, 26—with a connecting member 28 which in the illustrated embodiment is formed as a plug connector.

As will be described in detail in the following, an electrical conductor 30 is arranged radially between the inner hose 12 and the sheathing 22, the conductor extending from one end 24 to the other end 26 of the inner hose 12 and terminating in the connecting member 28 for electrical contact-making, as FIG. 10 shows. According to significant features of the hose 10 the electrical conductor 30 is formed by a resilient flat conductor arrangement 32 which extends along the hose 10 substantially without pre-stress and with electrical insulation parallely to the longitudinal axis 18. In this position the resilient flat conductor arrangement 32 is held at least by the sheathing 22 at the wave-shaped profiling 34 of the inner hose 12.

Merely the hose regions near the ends 24, 26 of the hose 10, which depending on the respective purpose of use can be several meters in length, are illustrated in FIGS. 1 and 2. In the case of central vacuum cleaners, for example, hose lengths between 6 and 15 meters are quite usual. In the illustrated embodiment the connecting members 28 at the two ends 24, 26 of the hose 10 are identically constructed as plug connectors. Obviously, other end members—for example a hand grip with a switch or several switches on one side and a plug connector on the other side or a combination of plug connector here and connecting socket there, etc.—are also conceivable here depending on the respective use requirements.

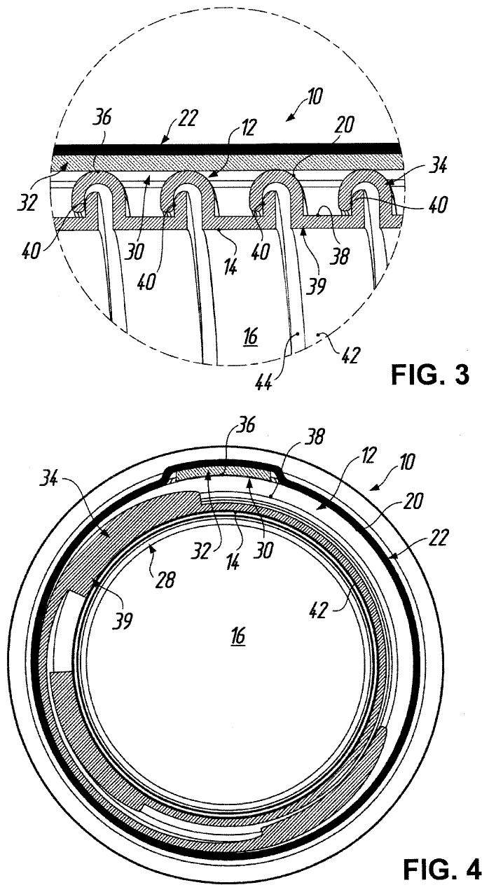

The wave-shaped profiling 34 of the inner hose 12 is to be seen in section along the longitudinal axis 18 of the hose 10 in FIGS. 2 and 3. Accordingly, the profiling 34, as seen in section, has a wave shape with alternating elevations 36 or wave crests and depressions 38 or wave valleys on the outer side. In the illustrated embodiment the elevations 36 and depressions 38 extend helically in a single start—or alternatively in a multiple start; not shown here—as seen in circumferential direction of the inner hose 12. This is explained by the fact that there is a wound inner hose 12 here, i.e. an inner hose 12, the wall of which is formed from a profile wound helically around the longitudinal axis 18, wherein adjacent windings of the profile 39 are media-tightly connected together.

The profile 39, which is here shown by way of example, of the inner hose 12 has, as seen in cross-section, two regions, namely a respective righthand region in FIG. 3, the cross-section of which has substantially the form of the letter U in “angular” form of writing and which at the wound inner hose 12 forms the outer depressions 38 of the profiling 34, and a respective lefthand region in FIG. 3, which as considered in cross-section has substantially the form of a letter C—which is in horizontal orientation or tipped through approximately 90° in clockwise sense—and which at the wound inner hose 12 forms the outer elevations 36 of the profiling 34. As can be readily seen in FIG. 3, the C-shaped region of a winding of the profile 39 is quasi “hooked” over the righthand limb of the U-shaped region of an adjacent winding of the profile 39 so that a respective short profile overlap arises thereat along the longitudinal axis 18. For media-tight connection of the adjacent windings of the profile 39 there is provided, for example, in the region of this profile overlap a hot-melt adhesive 40 forming a helically extending seam. The U-shaped regions of the profile 39 form on the inner side of the inner hose 12 a substantially smooth inner surface 42 of the hose 10, which is interrupted only by a narrow helical groove 44 formed between the individual windings of the profile 39, as can be best seen in FIG. 3.

In the illustrated embodiment the profile 39 of the inner hose 12 is extruded from a plastics material such as, for example, polyethylene (PE), polypropylene (PP) or an ethylene vinyl acetate copolymer (EVAC). As far as the hot-melt adhesive 40 is concerned, it can similarly comprise a plastics material such as, for example, PE or EVAC.

As the detail at the bottom in FIG. 1 clarifies, in the illustrated embodiment the sheathing 22 of the hose 10 is a braiding of the inner hose 12 of monofilamentary and/or multifilamentary plastics material threads as already briefly mentioned, which can comprise, for example, a thermoplastic plastics material such as, for example, polyamide (PA) or PE. During bending of the hose 10 the multifilamentary threads bear on the tension side flatly against the inner hose 12 and compress on the compression side of the inner hose 12 transversely to the thread and thus also towards the wall of the inner hose 12, so that the braiding 22 always rests on the wall. In addition, in the case of a particularly advantageous mixture ratio of 50% multifilamentary threads to 50% monofilamentary threads the braided surface of the hose 10 always remains closed.

According to FIGS. 3 and 4 the resilient flat conductor arrangement 32, which is illustrated thickly oversized in the sections of the drawing for the purposes of clarification, is pressed by the braiding 22 against the elevations 36 of the wave-shaped profiling 34. In these contact regions the resilient flat conductor arrangement 32 is thus mechanically positively held in radial direction of the hose 10 between the inner hose 12 and the braiding 22, whilst the pressing force, which is radially directed with respect to the longitudinal axis 18 of the hose 10, ensures a force-locking, i.e. frictional, fixing in longitudinal and circumferential directions of the hose 10.

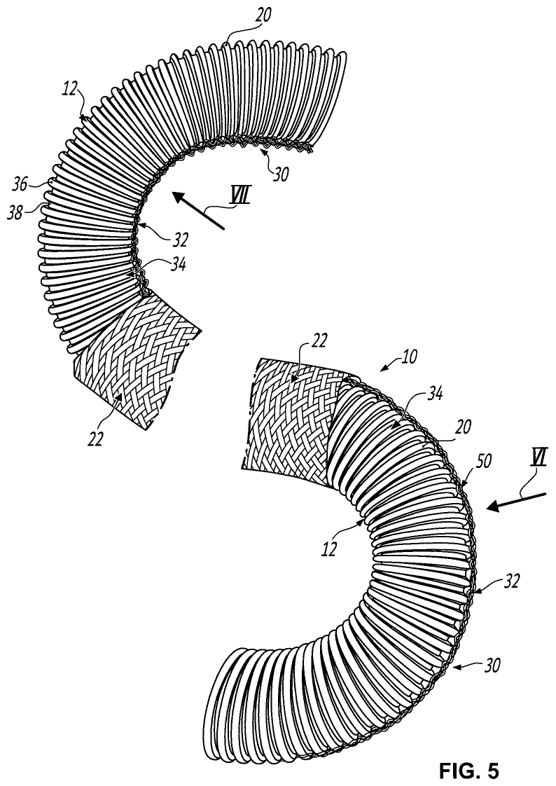

By virtue of its resilient configuration, the flat conductor arrangement 32 can reversibly lengthen or compress axially between these contact regions depending on the deformation of the flexible hose 10 under the respectively prevailing bending, torsional and/or tension/compression forces. This is illustrated in FIGS. 5 (at the bottom) and 6 for the case of lengthening during bending of the hose 10 and in FIGS. 5 (at the top) and 7 for the case of compression during bending of the hose 10.

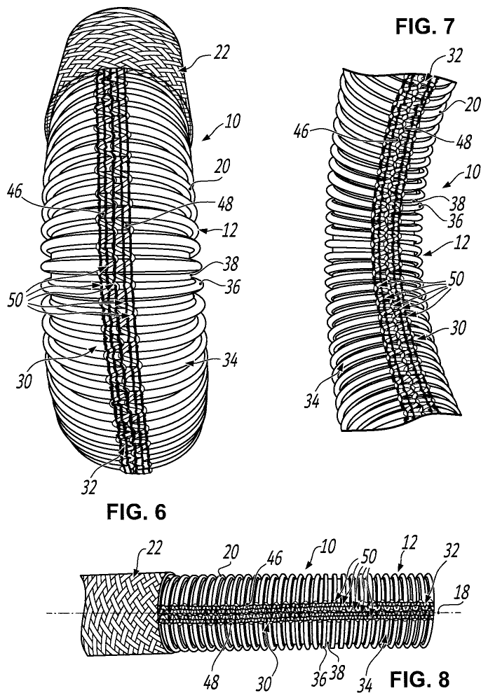

Further details of the resilient flat conductor arrangement 32 can be inferred from, in particular, FIGS. 6 to 8 as well as 10 (at the bottom left). Accordingly, the resilient flat conductor arrangement 32 comprises at least one flexible strand line 46, 48, in the illustrated embodiment two flexible strand lines 46, 48. In the depicted example each of the strand lines 46, 48 runs in zigzag shape (alternatively in loop shape) as seen in longitudinal direction of the flat conductor arrangement 32 and, in particular, so that the strand lines 46, 48 as considered transversely with respect to the flat conductor arrangement 32 run at an axial spacing from one another equally in zigzag shape (or loop shape), as can be best seen in FIG. 6. In that case, the respective strand line 46, 48 is fixed in its course by threads 50 which in the manner of a knitted fabric form around the respective strand line 46, 48 thread loops which are looped to form stitches.

The individual threads 50 of the knitted fabric shown here are at least in part resilient and can comprise, for example, a mixture of polyester or polyamide fibers with elastane fibers. It will be apparent to the person skilled in the art that after the resilient flat conductor arrangement 32 has been arranged, as seen in its longitudinal direction, at the outer side 20 of the inner hose 12 in alignment with a longitudinal axis 18 of the hose 10 (cf. FIGS. 2 and 8) the threads 50 of the knitted fabric at or in the hose 10 permit resilient elongation—for example in the “outer curve” according to FIGS. 5 (at the bottom) and 6—or resilient compression—for example in the “inner curve” according to FIGS. 5 (at the top) and 7—of the respective strand line 46, 48 in the zigzag-shaped (or loop-shaped) course thereof. In order in that case to further increase the friction couple of the resilient flat conductor arrangement 32 in its sandwiched position between the elevations 36 of the wave-shaped profiling 34 of the inner hose 12 and the sheathing 22 the flat conductor arrangement 32 can be provided with (partial) rubberization, for example by provision of corresponding threads 50 in the knitted fabric of the flat conductor arrangement 32.

As far as the individual electrical conductors of the resilient flat conductor arrangement 32 are concerned, each of the strand lines 46, 48 comprises a plurality of individual metallic wires as indicated in FIG. 10 at the lower left with the reference numeral 52 by splicing-on at the line ends. The respective strand line 46, 48 can also have between the metallic individual wires one or more plastics material threads for tension relief. In the illustrated embodiment the individual wires of the respective strand line 46, 48 are lacquer-insulated for electrical insulation. However, the respective strand line can as an alternative thereto or additionally also be provided with an extruded insulation of plastics material (not shown in the figures).

Further details of a possible connecting member 28 at the end 26 of the hose 10 are illustrated in FIG. 10. In the embodiment shown here the connecting member 28 has a contact region 54 which is electrically connected with the resilient flat conductor arrangement 32 and which comprises two slip rings 56. The two slip rings 56 of the contact region 54 are mounted at an axial spacing from one another on a sleeve-shaped slip ring carrier 58 of plastics material, which according to FIG. 10 is provided at its inner circumferential surface with screw projections 60. In the mounted state of the connecting member 28 the slip ring carrier 58 is screwed by its screw projections 60 onto the inner hose 12, more precisely the helically extending outer depressions 38 thereof, in which case the slip ring carrier 58 firmly clamps the sheathing 22 on the inner hose 12.

In this position the slip ring carrier 58 is additionally fixed to the inner hose 12 by a collar sleeve 62 which is pressed with friction couple to such an extent into the inner hose 12 that an annular collar 64 formed at the collar sleeve 62 comes into contact with a shoulder 66 (see FIG. 10) at the inner circumference of the slip ring carrier 58. In that case, projections 68 provided externally at the annular collar 64 of the collar sleeve 62 engage in associated windows 70 in the slip ring carrier 58 so that rotation of the slip ring carrier 58 about the longitudinal axis 18 of the hose 10 is no longer possible.

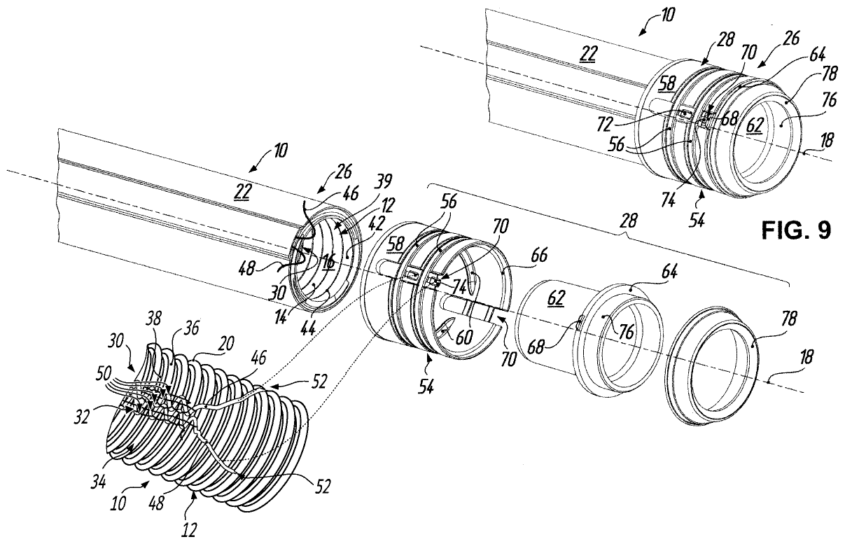

According to, in particular, FIGS. 1, 9 and 10, provided at the slip rings 56 are solder tabs 72, 74 to which the strand lines 46, 48 of the resilient flat conductor arrangement are soldered, as indicated by dashed lines in FIG. 10, so as to produce electrical contact of the contact region 54 of the respective connecting member 28 with the resilient flat conductor arrangement 32. Finally, an elastomeric annular seal 78 plugged onto an end annular projection 76 of the collar sleeve 62 completes the respective connecting member 28 of the flexible hose 10. In operation of the hose 10, this annular seal 78 serves the purpose of sealing between the connecting member 28 and an associated connecting socket (not shown).

A method of producing the flexible hose 10 described in that respect comprises in general the following three method steps a) to c): In a first step a), formation of an inner hose 12, which by an inner side 14 bounds a cavity 16 about a longitudinal axis 18 and has at least at an outer side 20 a profiling 34 which as seen in section has a wave shape with elevations 36 and depressions 38, is carried out. The “basic hose” produced in that respect is, in principle, already capable of use, i.e. no special demands are imposed thereon with regard to electrical equipping or a sheathing or braiding; thus this basic hose can already be made up by cutting to length and providing with suitable connecting members.

Only in a following step b) is there now carried out—in the case of demands on the hose 10 with respect to electrical equipping thereof—the substantially bias-free mounting of the afore-described resilient flat conductor arrangement 32 on the outer side 20 of the inner hose 12 so that the resilient flat conductor arrangement 32 extends along the longitudinal axis 18 and transversely to the elevations 36 and depressions 38 to the profiling 34. In other words, in this step the hose 10 is provided with the desired electrical conductor 30 which as a consequence of its design as a resilient flat conductor arrangement 32 is readily capable of following deformations of the hose 10, as already described further above. Since the resilient flat conductor arrangement 32 in that case runs along the inner hose 12, the (conductor) material usage and consequently also the hose weight are minimized by comparison with previously known solutions.

In order, ultimately, to maintain this “electrified” state in further processing and in later use of the hose 10, securing of the resilient flat conductor arrangement 32 to the outer side 20 of the inner hose 12 is carried out in a further step c) by mounting a sheathing 22 on the wave-shaped profiling 34 of the inner hose 12. This securing can, as also already mentioned above, be carried out by braiding the outer side 20 of the inner hose 12, optionally with assistance of an additional adhesive agent (adhesive or adhesive strip) on and/or under the resilient flat conductor arrangement 32, particularly in the region of the elevations of the wave-shaped profiling 34 of the inner hose 12.

Preferred sub-steps of the step a) of forming the inner hose 12 comprise, as also already discussed further above, initially a sub-step in which a profile 39 of a plastics material is extruded. The profile 39 for formation of the inner hose 12 is helically wound thereon in a further sub-step, wherein adjacent windings of the profile 39 are media-tightly connected together by, for example, the hot-melt adhesive 40, as is known per se.

With respect to especially rapid and efficient mass production of “electrified” flexible hoses 10 it is particularly preferred if the steps b) of mounting and c) of securing the resilient flat conductor arrangement 32 on and to the outer side 20 of the inner hose 12 are performed at the same time. This can be carried out, in particular, in such a way that the wave-shaped profiling 34 of the inner hose 12 is braided with monofilamentary and/or multifilamentary plastics material threads for formation of the sheathing 22, as is also known per se. However, this braiding is then undertaken with the feature that the resilient flat conductor arrangement 32 is placed substantially without pre-stress at the braiding point on the outer side 20 of the inner hose 12, so that after the braiding point the braided plastics material threads press the resilient flat conductor arrangement 32 against the elevations 36 of the wave-shaped profiling 34 of the inner hose 12.

It will be apparent to the person skilled in the art that in this way quasi any length of inner hoses 12 can be “electrified” and provided with a sheathing 22 within the scope of “continuous production”. After achieving the desired hose length, the braided inner hose 12 provided with the resilient flat conductor arrangement 32 is then suitably cut to length before further finishing-off of the hose 10 with the desired connecting members 28 can take place.

If, for example, the connecting member 28 shown in FIGS. 1, 2, 9 and 10 is mounted as depicted at the end 24 and/or 26 of the hose 10 then during the cutting to length or thereafter the resilient flat conductor arrangement 32 or at least the strand lines 46, 48 thereof is or are slightly withdrawn from their position between the inner hose 12 and sheathing 22, as indicated at the top left in FIG. 10. As a consequence, the electrical conductor can be stripped and soldered to the solder tabs 72, 74 of the slip ring 56 at the slip ring carrier 58 screwed onto the inner hose 12, whereupon the connecting member 28 can be mounted in finished state as already discussed further above.

A flexible hose, particularly vacuum cleaner hose, has an inner hose which is profiled in wave shape and which by an inner side bounds a cavity for the conveying of media along a longitudinal axis, the inner hose being surrounded at an outer side by a substantially smooth sheathing and being provided at at least one of its two ends with a connecting member. Arranged radially between the inner hose and the sheathing is an electrical conductor which extends from one end to the other end of the inner hose and ends in the connecting member for electrical contact-making. The electrical conductor is formed by a resilient flat conductor arrangement, which with electrical insulation extends parallel to the longitudinal axis along the hose and is held at the wave-shaped profiling of the inner hose at least by the sheathing, whereby particularly lengthy hoses equipped with electrical conductors and having a low weight can be economically produced. In addition, a method for producing such a hose on a large scale is proposed.

### REFERENCE NUMERAL LIST

10 hose
12 inner hose
14 inner side
16 cavity
18 longitudinal axis
20 outer side
22 sheathing, braiding
24 end
26 end
28 connecting member
30 electrical conductor
32 resilient flat conductor arrangement
34 wave-shaped profiling
36 elevation
38 depression
39 profile
40 hot-melt adhesive
42 inner surface
44 helical groove
46 strand line
48 strand line
50 threads
52 splicing-on
54 contact region
56 slip ring
58 slip ring carrier
60 screw projection
62 collar sleeve
64 annular collar
66 shoulder
68 projection
70 window
72 solder tab
74 solder tab
76 annular projection
78 annular seal

What is claimed is:

1. A flexible hose (10), with an inner hose (12) which is profiled for itself in wave shape and by an inner side (14) bounds a cavity (16) for the conveying of media along a longitudinal axis (18) of the hose (10) and which is surrounded at an outer side (20) by a substantially smooth sheathing (22) and provided at at least one of its two ends (24, 26) with a connecting member (28), wherein an electrical conductor (30) extending from one end (24) to the other end (26) of the inner hose (12) and ending in the connecting member (28) for electrical contact-making is arranged radially between the inner hose (12) and the sheathing (22), characterized in that the electrical conductor (30) is formed by a resilient flat conductor arrangement (32) which extends along the hose (10) parallel to the longitudinal axis (18) substantially without pre-stress and with electrical insulation and which is held on the wave-shaped profiling (34) of the inner hose (12) by the sheathing (22).

2. A flexible hose (10) according to claim 1, characterized in that the resilient flat conductor arrangement (32) is pressed against elevations (36) of the wave-shaped profiling (34) by the sheathing (22).

3. A flexible hose (10) according to claim 2, characterized in that the resilient flat conductor arrangement (32) is provided with a rubberization.

4. A flexible hose (10) according to claim 3, characterized in that the sheathing (22) is a braiding of monofilamentary and/or multifilamentary plastics material threads.

5. A flexible hose (10) according to claim 4, characterized in that the resilient flat conductor arrangement (32) comprises at least one strand line (46, 48), which extends in loop shape or zigzag shape as seen in longitudinal direction of the flat conductor arrangement (32) and is held in its course by threads (50) which in the manner of a knitted fabric form thread loops about the strand line (46, 48), that are looped into stitches.

6. A flexible hose (10) according to claim 5, characterized in that the resilient flat conductor arrangement (32) comprises at least two strand lines (46, 48) which extend at a mutual axial spacing equally in loop shape or zigzag shape as seen transversely to the flat conductor arrangement (32).

7. A flexible hose (10) according to claim 5 or 6, characterized in that the strand line (46, 48) of the resilient flat conductor arrangement (32) comprises a plurality of metallic individual wires and at least one plastics material thread for tension relief.

8. A flexible hose (10) according to claim 7, characterized in that the strand line (46, 48) of the resilient flat conductor arrangement (32) is provided with an extruded insulation or is lacquer-insulated.

9. A flexible hose (10) according to claim 8, characterized in that the threads (50) of the knitted fabric are resilient at least in part, wherein the threads (50) of the knitted fabric preferably comprise a mixture of polyester or polyamide fibers with elastane fibers.

10. A flexible hose (10′) according to claim 9, characterized in that the connecting member (28) has a contact region (54) with which the resilient flat conductor arrangement (32) is electrically connected, wherein the contact region (54) preferably comprises at least one slip ring (56).

11. A method of producing a flexible hose (10), particularly according to any one of the preceding claims, characterized by the following method steps:
a) forming an inner hose (12), which by an inner side (14) bounds a cavity (16) around a longitudinal axis (18) and has at least at an outer side (20) a profiling (34) which as seen in section has a wave shape with elevations (36) and depressions (38),
b) mounting of a resilient flat conductor arrangement (32) on the outer side (20) of the inner hose (12) substantially free of pre-stress so that the resilient flat conductor arrangement (32) extends along the longitudinal axis (18) and transversely to the elevations (36) and depressions (38) of the profiling (34) and
c) securing the resilient flat conductor arrangement (32) to the outer side (20) of the inner hose (12) by mounting a sheathing (22) on the wave-shaped profiling (34).

12. A method of producing a flexible hose (10) according to claim 11, characterized in that in the step a) of forming the inner hose (12) initially a profile (39) of a plastics material is extruded and then the profile (39) is helically wound to form the inner hose (12), wherein adjacent windings of the profile (39) are media-tightly connected together.

13. A method of producing a flexible hose (10) according to claim 12, characterized in that the adjacent windings of the profile (39) are media-tightly connected together by a hot-melt adhesive (40).

14. A method of producing a flexible hose (10) according to claim 13, characterized in that the steps b) of mounting and c) of securing the resilient flat conductor arrangement (32) on and to the outer side (20) of the inner hose (12) are carried out at the same time.

15. A method of producing a flexible hose (10) according to claim 14, characterized in that for formation of the sheathing (22) the wave-shaped profiling (34) of the inner hose (12) is braided by monofilamentary and/or multifilamentary plastics material threads, wherein the resilient flat conductor arrangement (32) is laid on the outer side (20) of the inner hose (12) substantially without pre-stress at the braiding point so that after the braiding point the braided plastics material threads press the resilient flat conductor arrangement (32) against the elevations (36) of the wave-shaped profiling (34) of the inner hose (12).

16. A flexible hose (10) according to claim 1, characterized in that the sheathing (22) is a braiding of monofilamentary and/or multifilamentary plastics material threads.

17. A flexible hose (10) according to claim 1, characterized in that the resilient flat conductor arrangement (32) comprises at least one strand line (46, 48), which extends in loop shape or zigzag shape as seen in longitudinal direction of the flat conductor arrangement (32) and is held in its course by threads (50) which in the manner of a knitted fabric form thread loops about the strand line (46, 48), that are looped into stitches.

18. A flexible hose (10′) according to claim 1, characterized in that the connecting member (28) has a contact region (54) with which the resilient flat conductor arrangement (32) is electrically connected, wherein the contact region (54) preferably comprises at least one slip ring (56).

19. A method of producing a flexible hose (10) according to claim 11, characterized in that the steps b) of mounting and c) of securing the resilient flat conductor arrangement (32) on and to the outer side (20) of the inner hose (12) are carried out at the same time.

20. A method of producing a flexible hose (10) according to claim 11, characterized in that for formation of the sheathing (22) the wave-shaped profiling (34) of the inner hose (12) is braided by monofilamentary and/or multifilamentary plastics material threads, wherein the resilient flat conductor arrangement (32) is laid on the outer side (20) of the inner hose (12) substantially without pre-stress at the braiding point so that after the braiding point the braided plastics material threads press the resilient flat conductor arrangement (32) against the elevations (36) of the wave-shaped profiling (34) of the inner hose (12).
